(19) United States
(12) Patent Application Publication
(10) Pub. No.: US 2023/0288943 A1
(43) Pub. Date: Sep. 14, 2023

(54) METHOD AND SYSTEM FOR CONTROLLING BULLDOZER AND CONVEYANCE VEHICLE

(71) Applicant: KOMATSU LTD., Tokyo (JP)

(72) Inventor: Yuuichi KADONO, Tokyo (JP)

(21) Appl. No.: 18/040,319

(22) PCT Filed: Aug. 17, 2021
(86) PCT No.: PCT/JP2021/030015

§ 371 Date: Feb. 2, 2023

(30) Foreign Application Priority Data
Oct. 23, 2020 (JP) 2020-177955

(51) Int. Cl. G05D 1/02; E02F 9/20; E02F 9/26; G08G 1/16

(52) U.S. Cl. CPC G05D 1/0291; E02F 9/205; E02F 9/261; G05D 1/0274; G08G 1/166; E02F 9/2228

(57) ABSTRACT

A first assessment is made as to whether conveying of earth and sand to a first unloading position by a conveyance vehicle has been completed. The conveyance vehicle is controlled to exit the first operating region when the conveying of the earth and sand to the first unloading position has been completed. A second assessment is made as to whether the conveyance vehicle has exited the first operating region. An entry of the conveyance vehicle into the first operating region is prohibited when the conveyance vehicle has exited the first operating region. An entry of a bulldozer into the first operating region is permitted after the entry of the conveyance vehicle into the first operating region has been prohibited.

### CROSS-REFERENCE TO RELATED APPLICATIONS

This application is a U.S. National stage application of International Application No. PCT/JP2021/030015, filed on Aug. 17, 2021. This U.S. National stage application claims priority under 35 U.S.C. § 119(a) to Japanese Patent Application No. 2020-177955, filed in Japan on Oct. 23, 2020, the entire contents of which are hereby incorporated herein by reference.

### TECHNICAL FIELD

The present disclosure relates to a method and a system for controlling a bulldozer and a conveyance vehicle.

### BACKGROUND INFORMATION

A system is known in the prior art that causes a conveyance vehicle to travel autonomously without being operated by a driver. For example, in the system disclosed in Japanese Patent Laid-open No. 2016-218576, a control server communicates wirelessly with a conveyance vehicle (referred to below as “autonomous travel vehicle”) that travels autonomously and acquires the position of the autonomous travel vehicle. The control server stores a map database that contains travel paths in a work site. The control server also communicates wirelessly with a vehicle (referred to below as “manned vehicle”) driven by a driver and acquires the travel position and the work state of the manned vehicle The control server controls the autonomous travel vehicle so as to avoid interfering with the manned vehicle based on the travel position of the manned vehicle and the map database.

### SUMMARY

Recently, a bulldozer is known that works by means of automatic control without being operated by a driver. When the bulldozer works by means of automatic control, there is a need to perform greater operation management in order to avoid interference with a conveyance vehicle that travels autonomously. An object of the present disclosure is to provide a technique for avoiding interference between a conveyance vehicle that travels autonomously and a bulldozer that travels autonomously.

### Means for Resolving the Problem

A method according to one aspect of the present disclosure is a method for controlling a bulldozer and a conveyance vehicle. The method according to the present aspect includes the following processes. A first process recognizes a first operating region where the bulldozer is not present in a work site. A second process determines a first unloading position in the first operating region. A third process controls the conveyance vehicle so as to convey earth and sand to the first unloading position. A fourth process assesses whether the conveying of the earth and sand to the first unloading position by the conveyance vehicle has been completed. A fifth process controls the conveyance vehicle so as to exit the first operating region when the conveying of the earth and sand to the first unloading position has been completed. A sixth process assesses whether the conveyance vehicle has exited the first operating region. A seventh process prohibits the conveyance vehicle from entering the first operating region when the conveyance vehicle has exited the first operating region. An eighth process permits entry of the bulldozer into the first operating region after the entry of the conveyance vehicle into the first operating region has been prohibited. The order of the execution of the processes is not limited to the above-mentioned order and may be changed.

A system according to another aspect of the present disclosure is a system for controlling a bulldozer and a conveyance vehicle. The system according to the present aspect includes a communication device and a controller. The communication device communicates with the bulldozer and the conveyance vehicle. The controller transmits command signals to the bulldozer and the conveyance vehicle via the communication device. The controller recognizes a first operating region where the bulldozer is not present inside a work site. The controller determines a first unloading position in the first operating region. The controller controls the conveyance vehicle so as to convey earth and sand to the first unloading position. The controller assesses whether the conveying of the earth and sand to the first unloading position by the conveyance vehicle has been completed. The controller controls the conveyance vehicle so as to exit the first operating region when the conveying of the earth and sand to the first unloading position has been completed. The controller assesses whether the conveyance vehicle has exited the first operating region. The controller prohibits the conveyance vehicle from entering the first operating region when the conveyance vehicle has exited the first operating region. The controller allows the entry of the bulldozer into the first operating region after the entry of the conveyance vehicle into the first operating region has been prohibited.

According to the present disclosure, interference between a conveyance vehicle that travels autonomously and a bulldozer that travels autonomously can be avoided.

### BRIEF DESCRIPTION OF DRAWINGS

FIG. 1 is a schematic view illustrating a control system of a bulldozer and a conveyance vehicle according to an embodiment.

FIG. 2 is a perspective view of the bulldozer.

FIG. 3 is a block diagram illustrating a configuration of the bulldozer.

FIG. 4 is side view of the conveyance vehicle.

FIG. 5 is a block diagram illustrating a configuration of the conveyance vehicle.

FIG. 6 is a top view of a work site.

FIG. 7 is a flowchart illustrating a process of the automatic control of the bulldozer and the conveyance vehicle.

FIG. 8 is a top view of a work area.

FIG. 9 is a top view of the work area.

FIG. 10 is a flowchart illustrating a process of the automatic control of the bulldozer and the conveyance vehicle.

FIG. 11 is a top view of the work area.

FIG. 12 is a flowchart illustrating a process of the automatic control of the bulldozer and the conveyance vehicle.

FIG. 13 is a top view of the work area.

### DESCRIPTION OF EMBODIMENTS

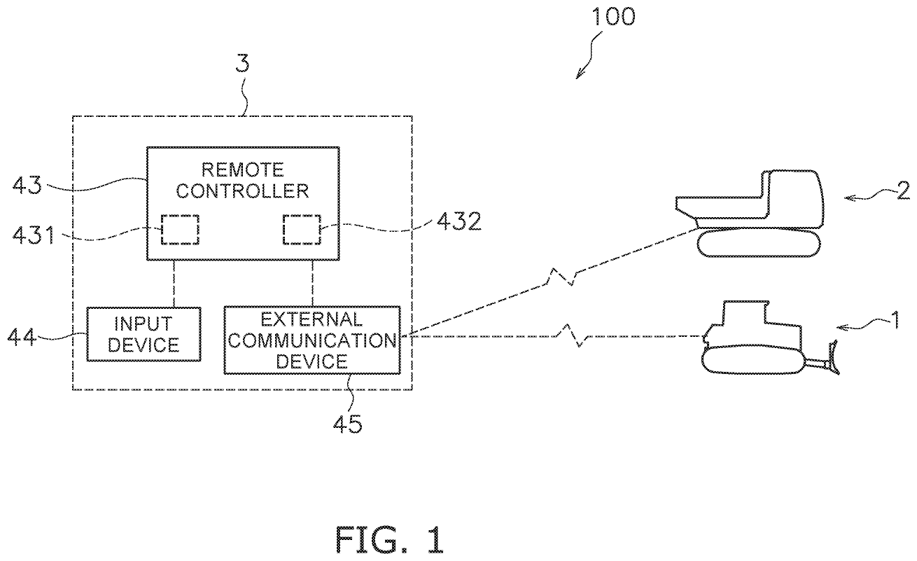

A system 100 according to an embodiment is discussed hereinbelow with reference to the drawings. FIG. 1 is a schematic view illustrating the system 100 according to the embodiment. The system 100 includes a bulldozer 1, a conveyance vehicle 2, and a remote control system 3. The system 100 controls the bulldozer 1 and the conveyance vehicle 2 disposed in a work site, such as an excavation site. The conveyance vehicle 2 is, for example, a dump truck. The bulldozer 1 and the conveyance vehicle 2 both travel autonomously without being driven by a driver. However, the bulldozer 1 and the conveyance vehicle 2 may be operated manually by an operator from a distance. The number of the bulldozers 1 is not limited to one and may be more than one. The number of the conveyance vehicles 2 is not limited to one and may be more than one.

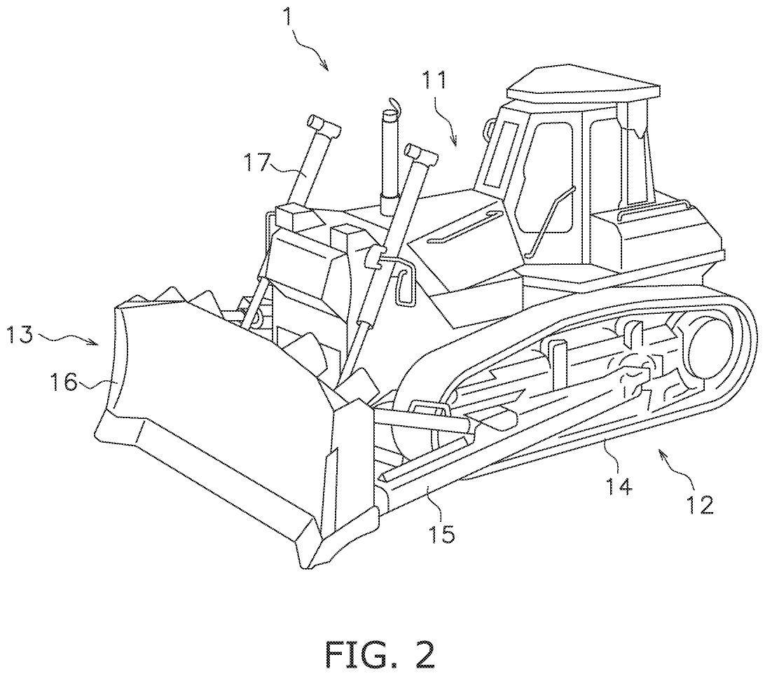

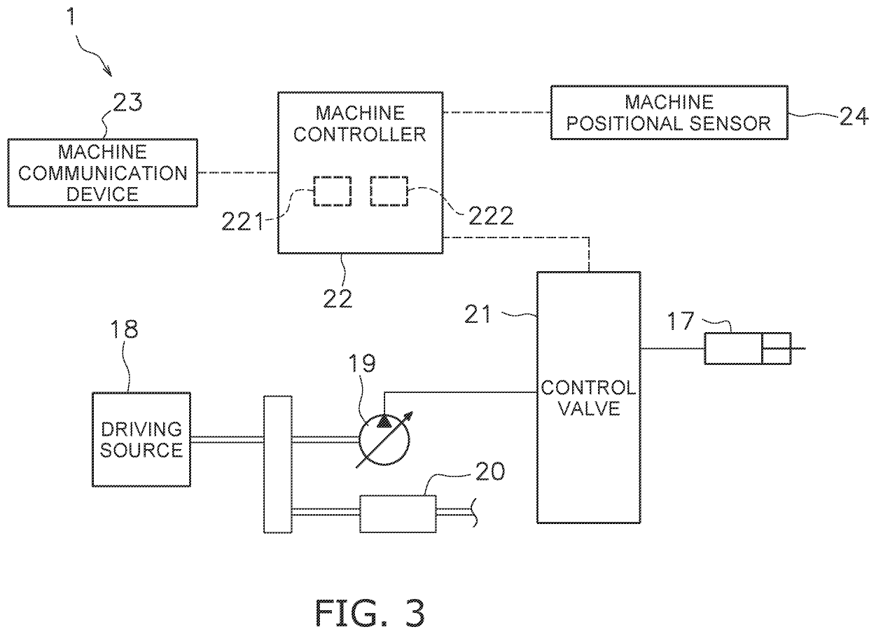

FIG. 2 is a perspective view of the bulldozer 1. FIG. 3 is a block diagram illustrating a configuration of the bulldozer 1. The bulldozer 1 includes a vehicle body 11, a travel device 12, and a work implement 13 as illustrated in FIG. 2. The vehicle body 11 is supported by the travel device 12. The travel device 12 includes crawler belts 14. The bulldozer 1 travels due to the rotation of the crawler belts 14.

The work implement 13 is attached to the vehicle body 11. The work implement 13 has a lift frame 15, a blade 16, and a lift cylinder 17. The lift frame 15 is attached to the travel device 12 in a manner that allows movement up and down. The lift frame 15 may also be attached to the vehicle body 11. The lift frame 15 supports the blade 16. The blade 16 moves up and down accompanying the movement of the lift frame 15. The lift cylinder 17 is coupled to the vehicle body 11 and the lift frame 15. The lift frame 15 moves up and down due to the extension and contraction of the lift cylinder 17.

As illustrated in FIG. 3, the bulldozer 1 includes a driving source 18, a hydraulic pump 19, a power transmission device 20, and a control valve 21. The driving source 18 is, for example, an internal combustion engine. The hydraulic pump 19 is driven by the driving source 18 and discharges hydraulic fluid. The hydraulic fluid discharged from the hydraulic pump 19 is supplied to the lift cylinder 17. While only one hydraulic pump is illustrated in FIG. 3, a plurality of hydraulic pumps may be provided.

The power transmission device 20 transmits the driving power of the driving source 18 to the travel device 12. The power transmission device 20 may be, for example, a hydrostatic transmission (HST). Alternatively, the power transmission device 20 may be, for example, a transmission having a torque converter or a plurality of speed change gears. Alternatively, the power transmission device 20 may be another type of transmission.

The control valve 21 is disposed between the hydraulic pump 19 and a hydraulic actuator, such as the lift cylinder 17. The control valve 21 controls the flow rate of the hydraulic fluid supplied to the lift cylinder 17 from the hydraulic pump 19. The control valve 21 may be a pressure proportional control valve. Alternatively, the control valve 21 may be an electromagnetic proportional control valve.

The bulldozer 1 includes a machine controller 22 and a machine communication device 23. The machine controller 22 controls the travel device 12 or the power transmission device 20 thereby causing the bulldozer 1 to travel. The machine controller 22 controls the control valve 21 whereby the blade 16 is moved up and down.

The machine controller 22 is programmed so as to control the bulldozer 1 based on acquired data. The machine controller 22 includes a processor 221 and a storage device 222. The processor 221 is, for example, a central processing unit (CPU). Alternatively, the processor 221 may be a processor different from a CPU. The processor 221 executes processing for controlling the bulldozer 1 in accordance with a program.

The storage device 222 includes a non-volatile memory, such as a ROM, and a volatile memory, such as a RAM. The storage device 222 may also include an auxiliary storage device, such as a hard disk or a solid state drive (SSD). The storage device 222 is an example of a non-transitory computer-readable recording medium. The storage device 222 stores computer commands and data for controlling the bulldozer 1.

The machine communication device 23 communicates wirelessly with the remote control system 3. For example, the machine communication device 23 communicates with the remote control system 3 via a wireless LAN such as Wi-Fi (trademark), via mobile communication, such as 3G, 4G, or 5G, or via another type of wireless communication network.

The bulldozer 1 includes a machine positional sensor 24. The machine positional sensor 24 includes, for example, a global navigation satellite system (GNSS) receiver, such as a global positioning system (GPS). Alternatively, the machine positional sensor 24 may include a receiver of another type of positioning system. The machine positional sensor 24 may also include a ranging sensor such as LIDAR or an image sensor, such as a stereo camera. The machine positional sensor 24 outputs positional data to the machine controller 22. The positional data indicates the current position of the bulldozer 1.

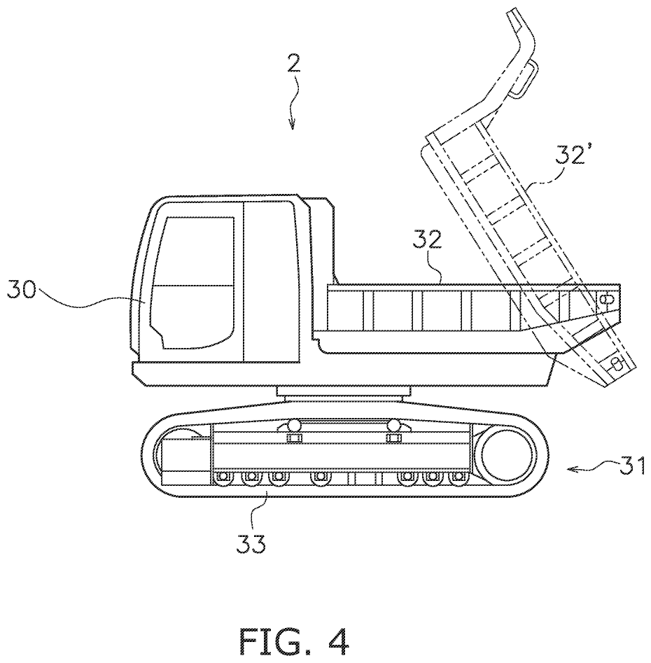

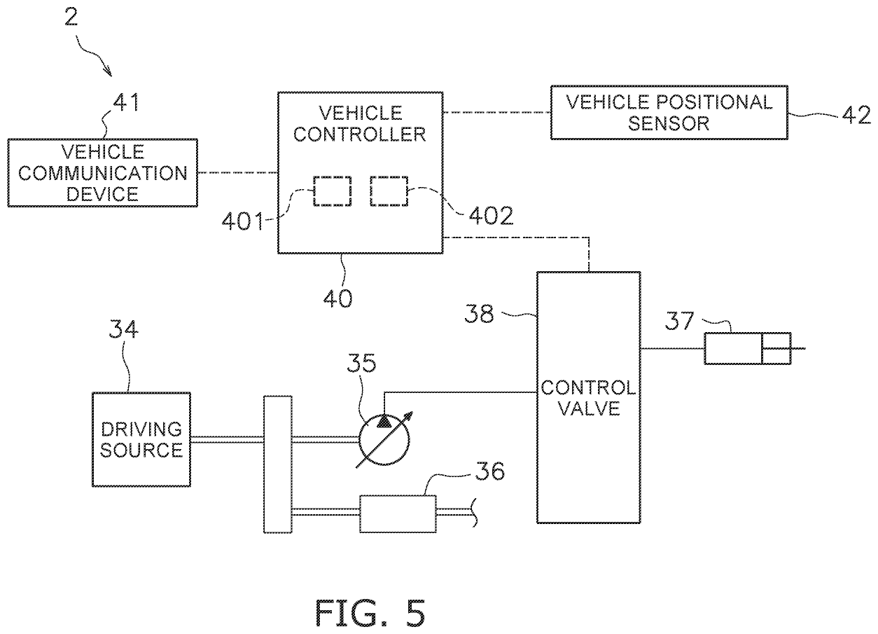

FIG. 4 is a side view of the conveyance vehicle 2. FIG. 5 is a block diagram illustrating a configuration of the conveyance vehicle 2. As illustrated in FIG. 4, the conveyance vehicle 2 includes a vehicle body 30, a travel device 31, and a bed 32. The vehicle body 30 is supported by the travel device 31. The travel device 31 includes crawler belts 33. The conveyance vehicle 2 travels due to the crawler belts 33 being driven. The travel device 31 may also include tires instead of the crawler belts 33.

The bed 32 is supported by the vehicle body 30. The bed 32 is provided so as to be able to move between a dumping attitude and a conveying attitude. In FIG. 3, the bed 32 indicated by the solid lines represents the position of the bed 32 in the conveying attitude. The bed 32′ indicated by the chain double-dashed lines represents the position of the bed 32 in the dumping attitude. In the conveying attitude, the bed 32 is disposed roughly horizontally. In the dumping attitude, the bed 32 is inclined with respect to the conveying attitude.

As illustrated in FIG. 5, the conveyance vehicle 2 includes a driving source 34, a hydraulic pump 35, a power transmission device 36, a lift cylinder 37, and a control valve 38. The driving source 34 is, for example, an internal combustion engine. The hydraulic pump 35 is driven by the driving source 34 and discharges hydraulic fluid. While only one hydraulic pump is illustrated in FIG. 5, a plurality of hydraulic pumps may be provided. The control valve 38 is disposed between the hydraulic pump 35 and the lift cylinder 37. The control valve 38 controls the flow rate of the hydraulic fluid supplied from the hydraulic pump 35 to the lift cylinder 37. The control valve 38 may also be a pressure proportional control valve. Alternatively, the control valve 38 may be an electromagnetic proportional control valve.

The power transmission device 36 transmits the driving power of the driving source 34 to the travel device 31. The power transmission device 36 may be, for example, a hydrostatic transmission (HST). The lift cylinder 37 is a hydraulic cylinder. The hydraulic fluid discharged from the hydraulic pump 35 is supplied to the lift cylinder 37. The lift cylinder 37 is driven by hydraulic fluid from the hydraulic pump 35. The lift cylinder 37 raises and lowers the bed 32. Consequently, the attitude of the bed 32 is switched between the conveying attitude and the dumping attitude.

The conveyance vehicle 2 includes a vehicle controller 40 and a vehicle communication device 41. The vehicle controller 40 controls the travel device 31 or the power transmission device 36 thereby causing the conveyance vehicle 2 to travel. The vehicle controller 40 controls the control valve 38 thereby switching the bed 32 between the conveying attitude and the dumping attitude.

The vehicle controller 40 is programmed so as to control the conveyance vehicle 2 based on acquired data. The vehicle controller 40 includes a processor 401 and a storage device 402. The processor 401 is, for example, a central processing unit (CPU). Alternatively, the processor 401 may be a processor different from a CPU. The processor 401 executes processing for controlling the conveyance vehicle 2 in accordance with a program.

The storage device 402 includes a non-volatile memory, such as a ROM, and a volatile memory, such as a RAM. The storage device 402 may also include an auxiliary storage device, such as a hard disk or a solid state drive (SSD). The storage device 402 is an example of a non-transitory computer-readable recording medium. The storage device 402 stores computer commands and data for controlling the conveyance vehicle 2.

The vehicle communication device 41 communicates wirelessly with the remote control system 3. For example, the vehicle communication device 41 communicates with the remote control system 3 via a wireless LAN, such as Wi-Fi (trademark), via mobile communication, such as 3G, 4G, or 5G, or via another type of wireless communication network.

The conveyance vehicle 2 includes a vehicle positional sensor 42. The vehicle positional sensor 42 includes, for example, a global navigation satellite system (GNSS) receiver, such as a global positioning system (GPS). Alternatively, the vehicle positional sensor 42 may include a receiver of another type of positioning system. The vehicle positional sensor 42 may include a ranging sensor, such as LIDAR or an image sensor, such as a stereo camera. The vehicle positional sensor 42 outputs positional data to the vehicle controller 40. The positional data indicates the current position of the conveyance vehicle 2.

The remote control system 3 is disposed, for example, in a management center separated from the work site. Alternatively, the remote control system 3 may be disposed in the work site. The remote control system 3 remotely controls the bulldozer 1 and the conveyance vehicle 2. As illustrated in FIG. 1, the remote control system 3 includes a remote controller 43, an input device 44, and an external communication device 45.

The external communication device 45 communicates wirelessly with the machine communication device 23 and the vehicle communication device 41. The external communication device 45 transmits command signals from the remote controller 43 to the machine communication device 23 and the vehicle communication device 41. The machine controller 22 receives the command signals via the machine communication device 23. The vehicle controller 40 receives the command signals via the vehicle communication device 41. The external communication device 45 receives the positional data of the bulldozer 1 via the machine communication device 23. The external communication device 45 receives the positional data of the conveyance vehicle 2 via the vehicle communication device 41.

The input device 44 is a device that is operable by an operator. The input device 44 receives an input command from the operator and outputs operation signals corresponding to the input command to the remote controller 43. The input device 44 outputs operation signals corresponding to an operation by the operator. The input device 44 outputs the operation signals to the remote controller 43. The input device 44 includes, for example, a mouse or a pointing device such as a track ball. The input device 44 may also include a keyboard. The input device 44 may also include a touchscreen.

The remote controller 43 receives operation signals from the input device 44. The remote controller 43 acquires the positional data of the bulldozer 1 from the bulldozer 1. The remote controller 43 acquires the positional data of the conveyance vehicle 2 from the conveyance vehicle 2. The remote controller 43 includes a processor 431 and a storage device 432. The processor 431 may be, for example, a central processing unit (CPU). Alternatively, the processor 431 may be a processor different from a CPU. The processor 431 executes processing for controlling the bulldozer 1 and the conveyance vehicle 2 in accordance with a program.

The storage device 432 includes a non-volatile memory, such as a ROM, and a volatile memory, such as a RAM. The storage device 432 may also include an auxiliary storage device, such as a hard disk or a solid state drive (SSD). The storage device 432 is an example of a non-transitory computer-readable recording medium. The storage device 432 stores computer commands and data for controlling the bulldozer 1 and the conveyance vehicle 2.

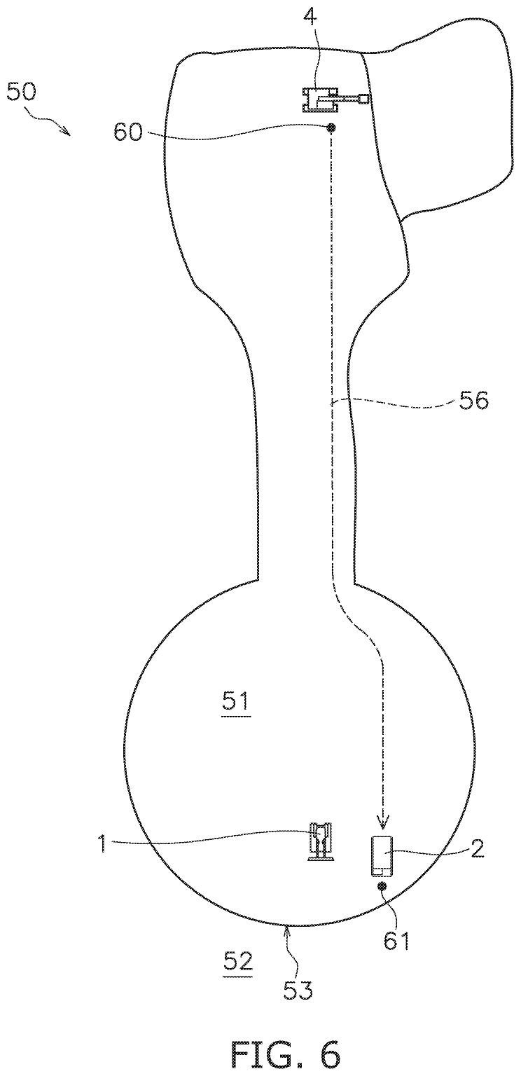

Automatic operation of the bulldozer 1 and the conveyance vehicle 2 executed by the system 100 will be explained next. FIG. 6 is a top view of the work site. The remote controller 43 stores actual topography data that represents an actual topography 50 of the work site. An excavating machine 4 is disposed at the work site. The excavating machine 4 excavates the actual topography 50. The excavating machine 4 may be automatically controlled by the remote controller 43. Alternatively, the excavating machine 4 may be operated manually.

The actual topography 50 includes a work area 51 and an unloading area 52. The remote controller 43 stores the position of the work area 51 assigned to the bulldozer 1. For example, a predetermined region in the work site is assigned to the bulldozer 1 as the work area 51 by an operation of the input device 44 by an operator. The remote controller 43 stores the position of the unloading area 52 and a boundary position 53 between the work area 51 and the unloading area 52. The remote controller 43 acquires, for example, the position of the unloading area 52 and the boundary position 53 from the actual topography data.

The remote controller 43 determines a loading position 60 and an unloading position 61. The loading position 60 is a position near the excavating machine 4. The loading position 60 may be determined by means of an operation of the input device 44 by an operator. Alternatively, the loading position 60 may be determined by the remote controller 43 from the position of the excavating machine 4.

The unloading position 61 is a position in the work area 51. The unloading position 61 is a position near the work area 51, the unloading area 52, and the boundary position 53. The unloading position 61 is discussed below. The remote controller 43 determines a travel path 56 that links the loading position 60 and the unloading position 61. The remote controller 43 determines the travel path 56 so that, for example, the travel distance of the conveyance vehicle 2 becomes the shortest distance. The remote controller 43 transmits data representing the travel path 56 to the conveyance vehicle 2.

The conveyance vehicle 2 travels autonomously along the travel path 56. The conveyance vehicle 2 moves to the loading position 60 and the excavated earth and sand is loaded onto the conveyance vehicle 2 at the loading position 60. The conveyance vehicle 2 moves along the travel path 56 and unloads the earth and sand from the bed 32 at the unloading position 61. Consequently, the earth and sand excavated by the excavating machine 4 is transported to the work area 51 assigned to the bulldozer 1. At the work area 51, the bulldozer 1 pushes the earth and sand placed in the work area 51 to the outside of the boundary position 53. Consequently, the earth and sand is discharged from the work area 51 to the unloading area 52.

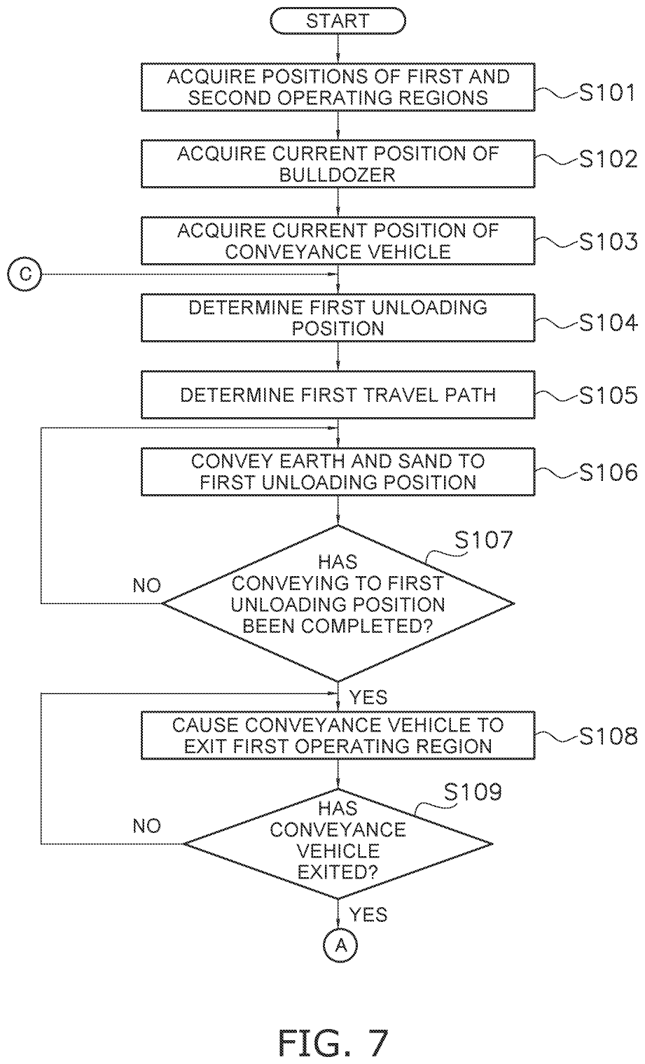

The automatic control for causing the bulldozer 1 and the conveyance vehicle 2 to work in conjunction will be explained below. FIG. 7 is a flow chart illustrating a process of the automatic control executed by the remote controller 43.

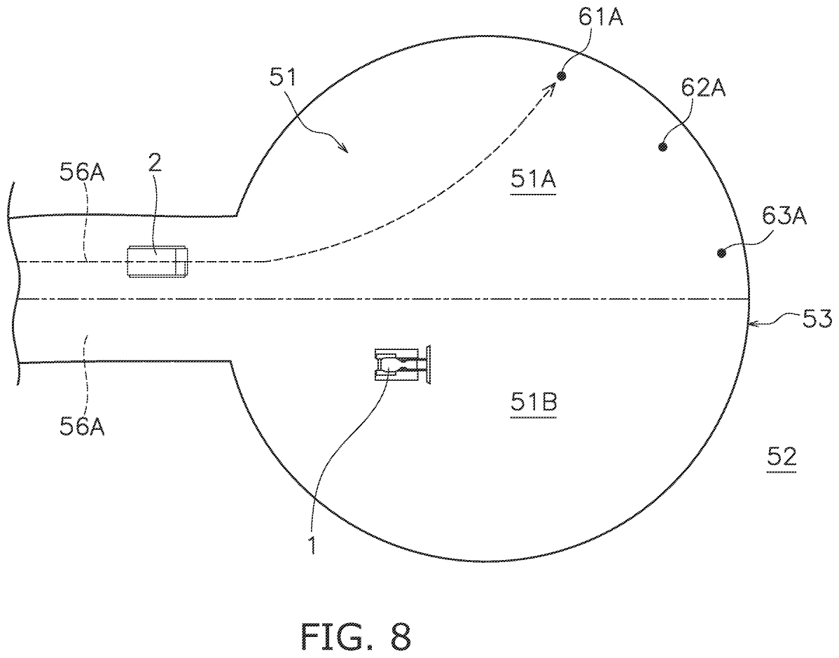

In step S101, the remote controller 43 acquires the position of a first operating region 51A and the position of a second operating region 51B. FIG. 8 is a top view of the work area 51. As illustrated in FIG. 8, the first operating region 51A and the second operating region 51B are located in the work area 51 and adjacent to each other. The remote controller 43 divides the work area 51 into two operating regions and determines the two operating regions as the first operating region 51A and the second operating region 51B. For example, the remote controller 43 determines the first operating region 51A and the second operating region 51B in response to an operation on the input device 44 by an operator.

In step S102, the remote controller 43 acquires the current position of the bulldozer 1. The remote controller 43 acquires the current position of the bulldozer 1 from the positional data of the bulldozer 1. In step S103, the remote controller 43 acquires the current position of the conveyance vehicle 2. The remote controller 43 acquires the current position of the conveyance vehicle 2 from the positional data of the conveyance vehicle 2.

In step S104, the remote controller 2 determines first unloading positions 61A-63A. The remote controller 43 determines the first unloading positions 61A-63A in an operating region where the bulldozer 1 is not present. For example, when the bulldozer 1 is positioned in the second operating region 51B and is not in the first operating region 51A, the remote controller 43 determines the plurality of first unloading positions 61A-63A in the first operating region 51A. The remote controller 43 may determine positions spaced away by a predetermined distance from the boundary position 53 in the first operating region 51A as the first unloading positions 61A-63A. The remote controller 43 may also determine the first unloading positions 61A-63A so that the plurality of first unloading positions 61A-63A are disposed at predetermined intervals.

In step S105, the remote controller 43 determines a first travel path 56A. The first travel path 56A is a path that links the loading position and the first unloading positions 61A-63A. The remote controller 43 determines the first travel path 56A of the conveyance vehicle 2 to the first unloading positions 61A-63A based on the current position of the bulldozer 1 and the first unloading positions 61A-63A so that interference between the conveyance vehicle 2 and the bulldozer 1 is avoided. The remote controller 43 determines the first travel path 56A so that, for example, the travel distance of the conveyance vehicle 2 becomes the shortest distance while avoiding interference with the bulldozer 1.

In step S106, the remote controller 43 controls the conveyance vehicle 2 so as to convey the earth and sand to the first unloading positions 61A-63A. The remote controller 43 causes the conveyance vehicle 2 to move along the first travel path 56A and unload the earth and sand from the bed 32 at the first unloading positions 61A-63A. The remote controller 43 may cause the earth and sand to be unloaded from the conveyance vehicle 2 at the plurality of first unloading positions 61A-63A by traveling one time along the first travel path 56A. Alternatively, the remote controller 43 may cause the earth and sand to be unloaded from the conveyance vehicle 2 at the plurality of first unloading positions 61A-63A by traveling multiple times along the first travel path 56A. The remote controller 43 prohibits the entry of the bulldozer 1 into the first operating region 51A while the earth and sand is being conveyed to the first unloading positions 61A-63A by the conveyance vehicle 2.

In step S107, the remote controller 43 assesses whether the conveying of the earth and sand to the first unloading positions 61A-63A by the conveyance vehicle 2 has been completed. For example, when all of the earth and sand has been unloaded to the first unloading positions 61A-63A, the conveyance vehicle 2 may transmit a report signal that indicates that the conveying has been completed to the remote controller 43. The remote controller 43 may assess that the conveying of the earth and sand to the first unloading positions 61A-63A has been completed based on the report signal from the conveyance vehicle 2.

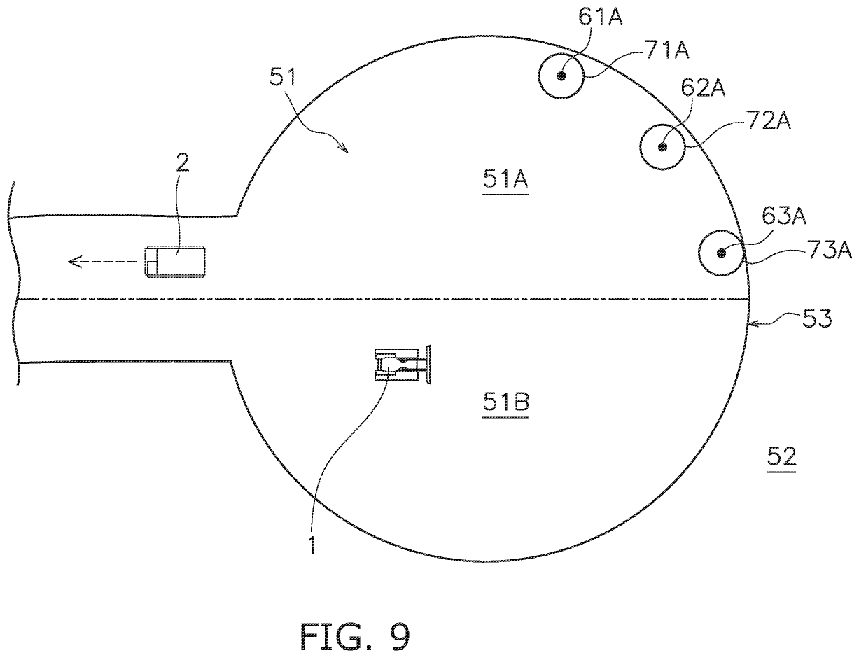

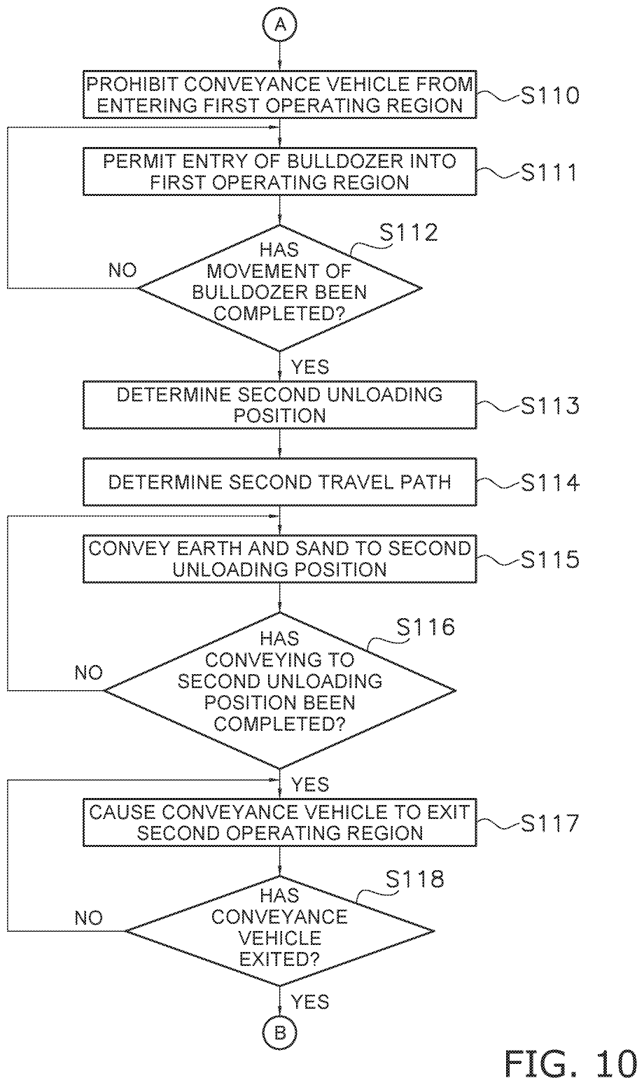

When the conveying of piles of earth and sand 71A-73A to the first unloading positions 61A-63A has been completed as illustrated in FIG. 9, the process advances to step S108. In step S108, the remote controller 43 controls the conveyance vehicle 2 so as to exit the first operating region 51A. The remote controller 43 controls the conveyance vehicle 2 so that the conveyance vehicle 2 moves to the loading position 60. In step S109, the remote controller 43 assesses whether the conveyance vehicle 2 has exited the first operating region 51A. When the conveyance vehicle 2 has exited the first operating region 51A, the process advances to step S110 illustrated in FIG. 10.

In step S110, the remote controller 43 prohibits the conveyance vehicle 2 from entering the first operating region 51A. In step S111, the remote controller 43 permits the bulldozer 1 to enter the first operating region 51A after the entry of the conveyance vehicle 2 into the first operating region 51A has been prohibited. Consequently, the bulldozer 1 is allowed to move from the second operating region 51B to the first operating region 51A.

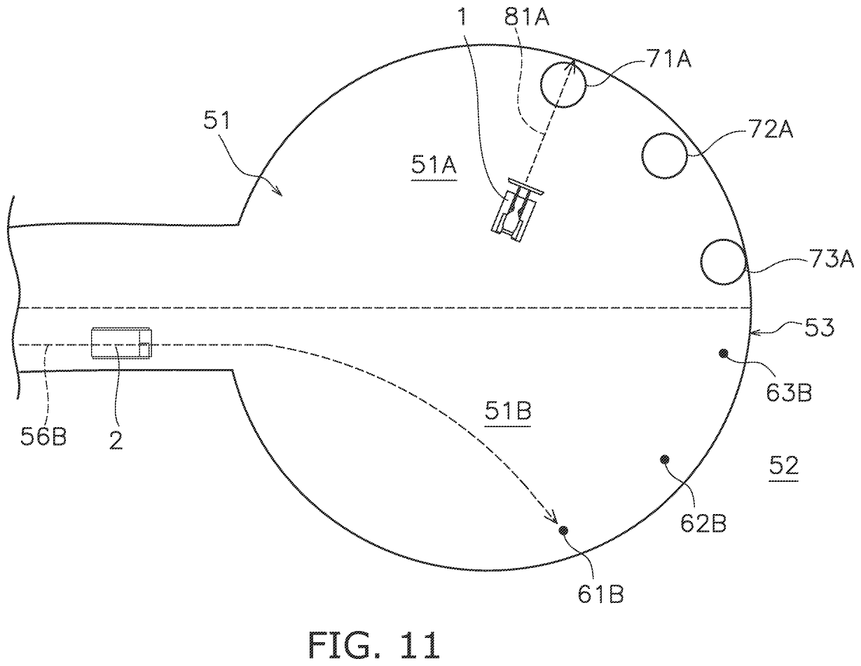

As illustrated in FIG. 11, the bulldozer 1 acquires a travel path 81A in the first operating region 51A for discharging the pile of earth and sand 71A placed in the first unloading positions 61A-63A toward the unloading area. The bulldozer 1 moves from the second operating region 51B to the first operating region 51A and along the travel path 81A in the first operating region 51A. Consequently, the pile of earth and sand 71A is pushed down from the boundary position 53 toward the unloading area 52.

The travel path 81A of the bulldozer 1 may be determined based on the first unloading position 61A, the boundary position 53, and the capacity of the blade 16. For example, the travel path 81A of the bulldozer 1 may be determined so that the movement distance of the bulldozer 1 becomes the shortest distance. The travel path 81A of the bulldozer 1 may be determined by the machine controller 22. The travel path 81A of the bulldozer 1 may be determined by the remote controller 43. The travel paths of the bulldozer 1 are determined in the same way for the piles of earth and sand 72A and 73A placed in the other first unloading positions 63A and 63A.

In step S112, the remote controller 43 determines whether the movement of the bulldozer 1 from the second operating region 51B to the first operating region 51A has been completed. For example, the remote controller 43 determines whether the movement of the bulldozer 1 from the second operating region 51B to the first operating region 51A has been completed based on the current position of the bulldozer 1. When the movement of the bulldozer 1 from the second operating region 51B to the first operating region 51A has been completed, the process advances to step S113.

In step S113, the remote controller 43 determines second unloading positions 61B-63B in the second operating region 51B and permits the movement of the conveyance vehicle 2 toward the second operating region 51B. As illustrated in FIG. 11, the remote controller 43 determines the plurality of second unloading positions 61B-63B in the second operating region 51B in the same way as the process for determining the first unloading positions 61A-63A in step S104.

In step S114, the remote controller 43 determines a second travel path 56B. The second travel path 56B is a path that links the loading position 60 and the second unloading positions 61B-63B. The remote controller 43 determines the second travel path 56B in the same way as the process for determining the first travel path 56A in step S105.

In step S115, the remote controller 43 controls the conveyance vehicle 2 so as to convey the earth and sand to the second unloading positions 61B-63B. The remote controller 43 causes the conveyance vehicle 2 to move along the second travel path 56B and unload the earth and sand from the bed 32 to the second unloading positions 61B-63B in the same way as the process for conveying the earth and sand to the first unloading positions 61A-63A in step S106. The remote controller 43 prohibits the entry of the bulldozer 1 into the second operating region 51B while the earth and sand is being conveyed to the second unloading positions 61B-63B by the conveyance vehicle 2.

In step S116, the remote controller 43 assesses whether the conveying of the earth and sand to the second unloading positions 61B-63B by the conveyance vehicle 2 has been completed. The remote controller 43 assess whether the conveying of the earth and sand to the second unloading positions 61B-63B has been completed in the same way as the process for determining whether the conveying of the earth and sand to the first unloading positions 61A-63A has been completed in step S107.

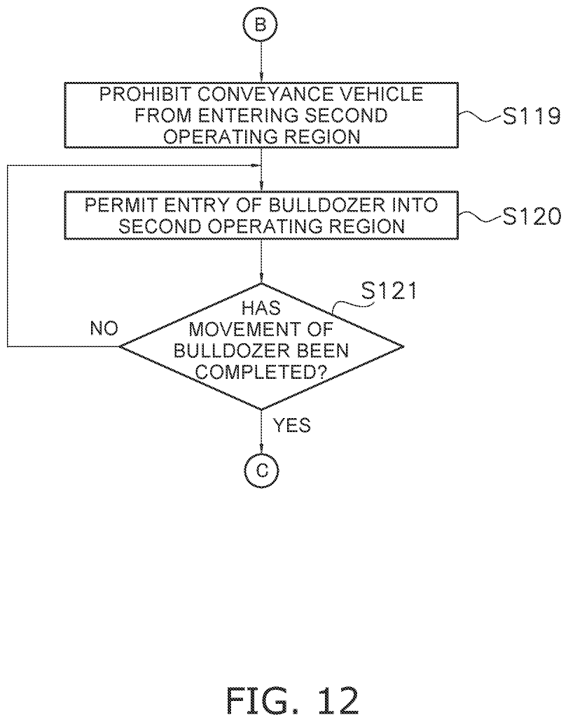

When the conveying of the earth and sand to the second unloading positions 61B-63B has been completed, the process advances to step S117. In step S117, the remote controller 43 controls the conveyance vehicle 2 so as to exit the second operating region 51B. In step S118, the remote controller 43 assesses whether the conveyance vehicle 2 has exited the second operating region 51B. When the conveyance vehicle 2 has exited the second operating region 51B, the process advances to step S119 illustrated in FIG. 12.

In step S119, the remote controller 43 prohibits the conveyance vehicle 2 from entering the second operating region 51B. In step S120, the remote controller 43 permits the bulldozer 1 to enter the second operating region 51B after the entry of the conveyance vehicle 2 into the second operating region 51B has been prohibited. Consequently, the bulldozer 1 is allowed to move from the first operating region 51A to the second operating region 51B.

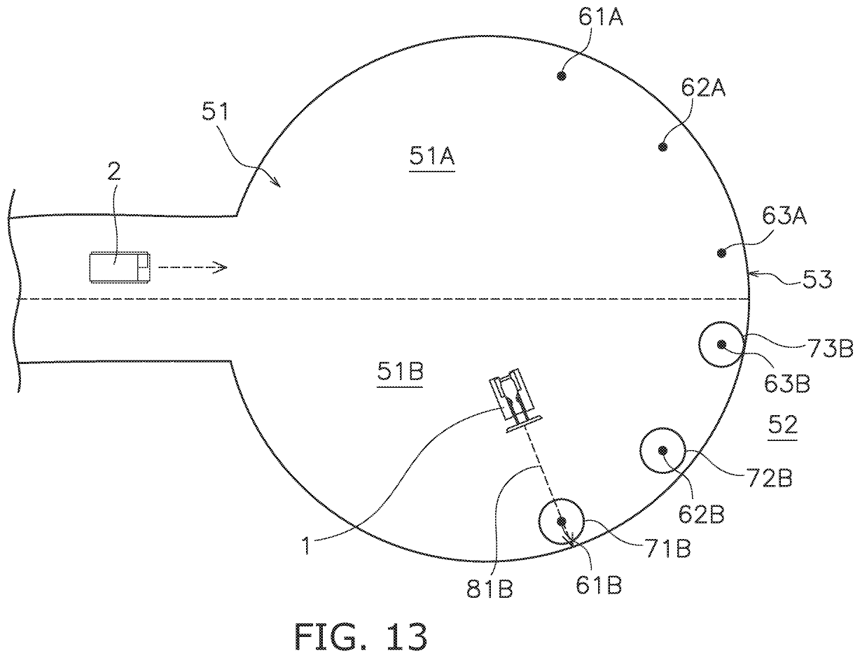

As illustrated in FIG. 13, the bulldozer 1 acquires a travel path 81B in the second operating region 51B for discharging the piles of earth and sand 71B-73B placed in the second unloading positions 61B-63B toward the unloading area 52. The process for the bulldozer 1 to discharge the earth and sand into the unloading area 52 in the second operating region 51B is the same as the process for the bulldozer 1 to discharge the earth and sand into the unloading area 52 in the first operating region 51A.

In step S121, the remote controller 43 determines whether the movement of the bulldozer 1 from the first operating region 51A to the second operating region 51B has been completed. When the movement of the bulldozer 1 from the first operating region 51A to the second operating region 51B has been completed, the process advances to step S104 in FIG. 7. In step S104, the remote controller 43 again determines the first unloading positions 61A-63A in the first operating region 51A.

By repeating the above processes, the conveying of the earth and sand to the first operating region 51A and the second operating region 51B by the conveyance vehicle 2 is repeated. Additionally, the discharging of the earth and sand at the first operating region 51A and the second operating region 51B to the unloading area 52 by the bulldozer 1 is repeated. At this time, permission and prohibition of entry into the first operating region 51A and the second operating region 51B by the bulldozer 1 is switched in response to the current position of the conveyance vehicle 2. Similarly, permission and prohibition of entry into the first operating region 51A and the second operating region 51B by the conveyance vehicle 2 is switched in response to the current position of the bulldozer 1. Consequently, work performed by the conveyance vehicle 2 and the bulldozer 1 by means of autonomous travel can be performed efficiently while avoiding interference between the conveyance vehicle 2 and the bulldozer 1.

Although an embodiment has been described so far, the present invention is not limited to the above embodiment and various modifications may be made within the scope of the invention. The conveyance vehicle 2 is not limited to a dump truck and may be another type of vehicle. The driving source 18 of the bulldozer 1 and/or the driving source 34 of the conveyance vehicle 2 are not limited to internal combustion engines and may be electric motors.

The remote controller 43, the machine controller 22, and/or the vehicle controller 40 may have a plurality of controllers that are separate from each other. The processes performed by the remote controller 43, the machine controller 22, and/or the vehicle controller 40 may distributed and executed among the plurality of controllers. The above-mentioned processes may distributed and executed among the plurality of processors.

The processes of the automatic control of the bulldozer 1 and/or the conveyance vehicle 2 are not limited to the above embodiment and may be changed, omitted, or other processes may be added. The sequence of the execution of the processes of the automatic control is not limited to the above embodiment and may be changed. A portion of the processes performed by the remote controller 43 may be executed by the machine controller 22 and/or the vehicle controller 40.

The number of divided operating areas is not limited to two and may be more than two. The number of the first unloading positions is not limited to three. The number of the first unloading positions may be less than three and may even be one. Alternatively, the number of the first unloading positions may be greater than three. The number of the second unloading positions is not limited to three. The number of the second unloading positions may be less than three and may even be one. Alternatively, the number of the second unloading positions may be greater than three.

According to the present disclosure, interference between a conveyance vehicle that travels autonomously and a bulldozer that travels autonomously can be avoided.

1. A method for controlling a bulldozer and a conveyance vehicle, the method comprising:
recognizing a first operating region where the bulldozer is not present in a work site;
determining a first unloading position in the first operating region;
controlling the conveyance vehicle to convey earth and sand to the first unloading position;
assessing whether conveying of the earth and sand to the first unloading position by the conveyance vehicle has been completed;
controlling the conveyance vehicle to exit the first operating region when the conveying of the earth and sand to the first unloading position has been completed;
assessing whether the conveyance vehicle has exited the first operating region;
prohibiting the conveyance vehicle from entering the first operating region when the conveyance vehicle has exited the first operating region; and
permitting entry of the bulldozer into the first operating region after prohibiting the conveyance vehicle from entering the first operating region.

2. The method according to claim 1, further comprising
acquiring a current position of the bulldozer; and
determining a travel path of the conveyance vehicle to the first unloading position based on the current position of the bulldozer and the first unloading position.

3. The method according to claim 1, further comprising
acquiring a current position of the bulldozer;
recognizing a second operating region where the bulldozer is present;
assessing whether the bulldozer has completed moving from the second operating region to the first operating region; and
permitting the conveyance vehicle to move to the second operating region after the
moving of the bulldozer from the second operating region to the first operating region has been completed.

4. The method according to claim 3, further comprising
determining a second unloading position in the second operating region;
controlling the conveyance vehicle to convey earth and sand to the second unloading position;
assessing whether conveying of the earth and sand to the second unloading position by the conveyance vehicle has been completed;
controlling the conveyance vehicle to exit the second operating region when the conveying of the earth and sand to the second unloading position has been completed;
assessing whether the conveyance vehicle has exited the second operating region;
prohibiting the conveyance vehicle from entering the second operating region when the conveyance vehicle has exited the second operating region; and
permitting entry of the bulldozer into the second operating region after prohibiting the conveyance vehicle from entering the second operating region.

5. The method according to claim 3, wherein
the second operating region is adjacent to the first operating region.

6. The method according to claim 3, further comprising
acquiring a position of a work area assigned to the bulldozer in the work site; and
dividing the work area into a plurality of operating regions including the first operating region and the second operating region, and recognizing the plurality of operating regions.

7. A system for controlling a bulldozer and a conveyance vehicle, the system comprising
a communication device configured to communicate with the bulldozer and the conveyance vehicle; and
a controller configured to
transmit command signals to the bulldozer and the conveyance vehicle via the communication device,
recognize a first operating region where the bulldozer is not present in a work site,
determine a first unloading position in the first operating region,
control the conveyance vehicle to convey earth and sand to the first unloading position,
assess whether conveying of the earth and sand to the first unloading position by the conveyance vehicle has been completed,
control the conveyance vehicle to exit the first operating region when the conveying of the earth and sand to the first unloading position has been completed,
assess whether the conveyance vehicle has exited the first operating region,
prohibit the conveyance vehicle from entering the first operating region when the conveyance vehicle has exited the first operating region, and
permit entry of the bulldozer into the first operating region after prohibiting the conveyance vehicle from entering the first operating region.

8. The system according to claim 7, wherein
the controller is further configured to
acquire a current position of the bulldozer, and
determine a travel path of the conveyance vehicle to the first unloading position based on the current position of the bulldozer and the first unloading position.

9. The system according to claim 7, wherein
the controller is further configured to
acquire a current position of the bulldozer,
recognize a second operating region where the bulldozer is present,
assess whether the bulldozer has completed moving from the second operating region to the first operating region, and
permit the conveyance vehicle to move to the second operating region after the moving of the bulldozer from the second operating region to the first operating region has been completed.

10. The system according to claim 9, wherein
the controller is further configured to
determine a second unloading position in the second operating region,
control the conveyance vehicle to convey earth and sand to the second unloading position,
assess whether conveying of the earth and sand to the second unloading position by the conveyance vehicle has been completed,
control the conveyance vehicle to exit the second operating region when the conveying of the earth and sand to the second unloading position has been completed,
assess whether the conveyance vehicle has exited the second operating region,
prohibit the conveyance vehicle from entering the second operating region when the conveyance vehicle has exited the second operating region, and
permit entry of the bulldozer into the second operating region after prohibiting the conveyance vehicle from entering the second operating region.

11. The system according to claim 9, wherein
the second operating region is adjacent to the first operating region.

12. The system according to claim 9, wherein
the controller is further configured to
acquire a position of a work area assigned to the bulldozer in the work site, and
divide the work area into a plurality of operating regions including the first operating region and the second operating region, and recognize the plurality of operating regions.
